(19) United States
(12) Patent Application Publication
(10) Pub. No.: US 2025/0176477 A1
(43) Pub. Date: Jun. 5, 2025

(54) HEIGHT ADJUSTABLE VENTILATION SYSTEM

(71) Applicant: Beektech Industries B.V., Bleiswijk (NL)

(72) Inventor: Hans Weisbeek, Bleiswijk (NL)

(21) Appl. No.: 18/837,631

(22) PCT Filed: Mar. 6, 2023
(86) PCT No.: PCT/EP2023/055581

§ 371 Date: Aug. 12, 2024

(30) Foreign Application Priority Data
Mar. 7, 2022 (NL) 2031170

(51) Int. Cl. A01G 9/24; F24F 7/06

(52) U.S. Cl. CPC A01G 9/246; F24F 7/065

(57) ABSTRACT

A ventilation system for air ventilation in greenhouses includes a shaft with an upper inlet side and a lower outlet side, where the shaft is configured for suspending from a truss. The system further including a first fan that is fluidly connected to the lower outlet side of the shaft. The first fan is configured for displacing air in a first air displacement direction from the upper inlet side to the lower outlet side of the shaft and into the greenhouse. The height of the shaft is adjustable to a height of the truss.

### CROSS-REFERENCE TO RELATED APPLICATIONS

This application is the National Stage of International Application No. PCT/EP2023/055581, filed Mar. 6, 2023, which claims the benefit of Netherlands Application No. 2031170, filed Mar. 7, 2022, the contents of which is incorporated by reference herein.

### FIELD OF THE INVENTION

The present invention relates to a height adjustable ventilation system, in particular for ventilation in greenhouses.

### BACKGROUND OF THE INVENTION

Good ventilation is crucial for the proper functioning of a greenhouse. It is essential for both proper temperature and humidity management, in order to maintain an optimal growing environment and to improve the overall efficiency of a greenhouse. Ventilation is also important for air circulation and carbon dioxide replenishment. Poor air circulation reduces plant activity and can lead to problems with humidity and disease control.

The most common form of air ventilation in greenhouses is passive ventilation. Passive ventilation uses openings in the sides or roof of the greenhouse to naturally draw in air or let air out of the growing space. Roof ventilation is a more effective method of air ventilation than sidewall ventilation, as the warm air at the bottom of the greenhouse naturally rises to the ridge of a greenhouse, creating an airflow to the roof openings where outside air enters the growing space.

Many greenhouses nowadays use climate screens that prevent light entering or leaving the greenhouse. These climate screens prevent daylight from entering the greenhouse. As a result, plants can be sheltered from excessive light and the length of the day can be artificially shortened for plants and products to be produced all year round. An additional advantage of these screens is that the artificial light inside the greenhouse is reflected by means of a reflective, e.g. white, surface on the underside of many climate screens, thereby increasing the efficiency of the greenhouse. In addition, national regulations may require greenhouses to have a climate screen to prevent light pollution at night. The climate screens are generally placed at the top of the greenhouse, often attached to a truss which serves as a supporting structure in the greenhouse. Although these screens are excellent for preventing light pollution, they also disturb the natural air ventilation and circulation of greenhouses. The airflow cannot reach the open vents at the ridges of the greenhouse, thereby preventing fresh air from entering the growing space. Consequently, controlling the temperature, humidity and carbon dioxide levels becomes more difficult and requires more time, additional equipment and energy.

DE2931359 discloses a mobile heater for a greenhouse that is positioned on the ground. The heater comprises a height adjustable air shaft with an upper part having an inlet opening and a bottom part having an outlet opening. Air moves into the shaft via the inlet opening, where it is heated by an electrically operated heating element. The heated air is then distributed via the outlet opening near the ground.

Similarly, WO2012093938 A2 discloses a displacement ventilation system with a height adjustable air channel. Air is displaced from a suction opening at the top of the channel to an air supply opening at the bottom of the system. From the air supply opening, the air is distributed at the bottom of the greenhouse.

A disadvantage of the systems disclosed in DE2931359 and WO2012093938 A2 is that the dispersion of the air near the ground is detrimental to the plants. The heated or cooled air is often too hot or too cold to directly contact the plant. Moreover, the distribution of air may cause turbulence of the air near the plants.

KR20100005834 discloses a greenhouse air circulation device for cooling and dehumidifying a greenhouse. The machine has a suction pipe made of an elastic material. The suction pipe is mounted to a case with a heat exchange coil and a fan. Air is sucked from the bottom of the greenhouse upwardly into the case where the air is cooled and dehumidified. The air is then dispersed horizontally.

A disadvantage of such a circulation device is the upwards displacement of the greenhouse air. The upwards displacement of air prevents proper mixing of the air at the bottom of the greenhouse with fresh air at the top of the greenhouse. This is especially true when there are closed climate screens present in the greenhouse.

Commercial solutions that solve the disruption of the air flow, such as the Ventilation Jet system (source: https://hinova.nl/producten/het-ventilationjet-systeem/), have already been placed in greenhouses. These ventilation systems comprise a flat tube which can be attached to the truss of the greenhouse, in between the climate screens. These systems comprise an opening at the top of the tube, facing towards the greenhouse ridge, through which fresh air can enter. A fan can be placed at the bottom side of the tube to draw in air through the tube to below the climate screens. The greenhouse can thus be ventilated while simultaneously maintaining the advantages of the climate screens.

Unfortunately, these air ventilation systems are problematic to produce and install in different types of greenhouses, as the truss specification can differ from one greenhouse to another. Due to the geometrical dimensions of the ventilation systems, where the fan is significantly larger than the shaft, the length of the shaft must be larger than the height of the truss. Consequently, the ventilation systems must be custom made to fit the corresponding truss. This is a time consuming and expensive process. Moreover, transportation of the systems is inconvenient due to the large dimensions of the system.

### SUMMARY OF THE INVENTION

The present invention aims to overcome the above disadvantage or to provide a suitable alternative.

In particular the present invention aims at providing a ventilation system which can be placed in any greenhouse irrespective of the height of the truss.

In a first aspect, the present invention relates to a ventilation system for air ventilation in greenhouses, comprising
a shaft with an upper inlet side and a lower outlet side, wherein the shaft is configured for suspending from a truss, and
a first fan that is fluidly connected to the lower outlet side of the shaft,
wherein the first fan is configured for displacing air in a first air displacement direction from the upper inlet side to the lower outlet side of the shaft and into the greenhouse, and
wherein a height of the shaft is adjustable to a height of the truss.

The shaft of the ventilation system is configured for receiving air and may be positioned vertically. The shaft comprises an upper inlet side at the top of the shaft that points substantially upwards and a lower outlet side which points substantially downwards. A first fan is fluidly connected to the lower outlet side of the shaft. The first fan is configured for drawing in air from the upper inlet side of the shaft to the lower outlet side, from which is it distributed through the fan.

The ventilation system according to the invention may suspend from a truss in a greenhouse. The height of these trusses (which may alternatively be named trellis or trellis gird) may vary from one greenhouse to another. The ventilation system according to the invention advantageously comprises a shaft that is adjustable in height to the height of the trellis. The height adjustable shaft advantageously allows the ventilation system to be hung on any type of truss, despite of its geometrical dimensions. This eliminates the need to customize the ventilation system for each type of truss, thereby saving both time and cost. Moreover, because of the height of the shaft matching the height of the truss, from above the truss (which is often includes fresh outside air) may be distributed below the truss and into the greenhouse. This also applies to the situation wherein closed climate screens are present in the greenhouse. An additional advantage of the system is that, in contrast to prior art ventilation systems, the fresh air leaving the lower outlet side, which is often too hot or too cold for the crops, is mixed with the greenhouse air before contacting the crops at the bottom of the growing space. Preferably, the height of the shaft can be adjusted is in the range of 10-80 cm, such as between 30-68 cm.

In an embodiment of the invention, the shaft comprises a bottom part and an upper part that are telescopically connected. The shaft is therefore adjustable in height. In a preferred embodiment of the invention, a portion of the upper part telescopically extends within the bottom part of the shaft. This arrangement advantageously prevents the disruption of the flow of air as it is displaced from the upper inlet side to the lower outlet side of the shaft. Alternatively, a portion of the bottom part can telescopically extend within the upper part of the shaft. In this configuration, a seal, such as a rubber, may be added to the circumference of the bottom edge of the upper part to prevent loss of air through the gap between the upper and bottom part instead of through the outlet of the shaft.

In an embodiment of the invention, the telescopic arranged upper part and bottom part are connected by an extension system. The extension system can for example comprise two bars, an upper and a lower bar, that together extend over a portion of the shaft, preferably over the entire height of the shaft. The extension system further comprises a block in which the lower bar is fixedly connected, for example with glue, and through which the upper bar protrudes. The lower bar is furthermore fixedly mounted to the bottom part of the shaft. The upper bar is rotatably mounted to the upper part of the shaft, e.g. with a coupling plate. The upper bar is preferably a screw thread that protrudes through the block, wherein the block preferably comprises internal threading that the screw thread can engage. Advantageously, when the upper bar is rotated with respect to the coupling plate, the block moves upwards or downwards on the upper bar, simultaneously raising or lowering the bottom part of the shaft. Consequently, the height of the shaft respectively increases or decreases during rotation of the upper bar. To ease the rotation of the upper bar, the upper bar can for example comprise a rivet fixedly connected to the top end of the bar. The cap nut can be rotated manually or using e.g. a power wrench.

Alternatively, the shaft may comprise a harmonic structure configured for extending or contracting, thereby respectively increasing or decreasing the height of the shaft.

In a preferred embodiment of the invention, the ventilation system comprises two or more extension systems positioned at a distance from each other in the shaft.

In a preferred embodiment of the invention, the shaft comprises attachment means mounted on the outside of the shaft configured to engage a supporting structure, such as a truss. These attachment means are preferably hooks. The attachment means are preferably easily interchangeable, such that attachment means that are compatible to the width of the beam of the truss can easily be attached to the shaft. Alternatively, the attachment means may be extendable to be adjusted to the width of the beams of the truss. Preferably the attachment means are mounted to the upper part of the shaft. The upper edge of the lower part may have recesses, such as slits, for accommodating the attachment means in a retracted position of the shaft.

In a preferred embodiment of the invention, the shaft has a small width such that it resembles a flat tube. This configuration ensures that the shaft can fit in the gap between adjacent climate screens that might be present in a greenhouse and that are closed during night time or during times of intense sunshine. Greenhouses may comprise one or multiple layers of these climate screens, of which each climate screen can also be placed in a different direction. Due to the limited space that is present in between these screens, ventilation systems generally require making holes in these screens to ensure fresh air from above the screens can be delivered to the growing space. Advantageously, the ventilation system according to the invention can be placed in between the climate screens to ensure that fresh air from above the screens can be drawn through the shaft to the growing space below the climate screens. A flat tube configuration is thus advantageous for dispersing fresh air through the entire green house, even when these screens are closed. Typically the shaft will have a mouth at the lower outlet side that is configured for accommodating the first fan leaving free a small gap between the inner periphery of the shaft mouth and the blades of the first fan.

In a preferred embodiment of the invention, the ventilation system comprises an air deflector that is attached to the bottom of the first fan, and that is configured to deflect the air in an air displacement direction perpendicular of the first air displacement direction in the shaft. As the ventilation system is preferably positioned vertically, the air deflector deflects the air preferably horizontally through the growing area. This air deflector prevents the fresh air, that is often too hot or too cold, from directly contacting the crops at the bottom of the growing space. Advantageously, due to the horizontal distribution, the fresh air is first mixed with the present air to ensure optimal temperature and humidity conditions.

In an embodiment of the invention, the ventilation system comprises a second fan that is placed below the first fan, e.g. below the air deflector if present in the system. The second fan is configured for drawing in air from the greenhouse axially, from which it distributes the air in a second air displacement direction which comprises a radial component as seen from the first air displacement direction. For example, the second fan is configured to force the air away in a downwardly oblique direction. As a result, the fresh outside air is mixed with the air inside the growing space. By distributing the air, the climate conditions such as heat, humidity and carbon dioxide concentration in the greenhouses are improved, which promotes a uniform development of the crop being grown. Climate disruptions are thus prevented and preheating of the fresh air is unnecessary. Additionally or alternatively, one or multiple fans can be placed at a distance from the ventilation system to ensure even distribution of the air in the greenhouse.

In an embodiment of the invention, the second fan is configured for displacing air by means of vertical vane blades.

In a preferred embodiment of the invention, the fans are operated by drive means. The drive means can be chosen from known devices, such as electrical or pneumatic motor systems.

In a further preferred embodiment of the invention, the capacity of the fans, in particular by its rotation speed, is controlled by climate control modules on a computer. Controlling of the fans may be achieved remotely, e.g. through suitable (wireless) transmission means from a central control system. For example, the system can be included in a wireless network so that only local power connections are required for the ventilation system according to the invention. The climate control system can preferably register each fan separately to optimize the climate in the growing space.

In a second aspect, the present invention relates to a greenhouse comprising a plurality of truss and climate screens and comprising at least one ventilation system according to the invention that is attached to the truss and that is positioned in a gap in between adjacent climate screens.

In a third aspect, the present invention relates to a method for installing a ventilation system according to the invention in a greenhouse, comprising the step of adjusting the height of the shaft thereby obtaining a shaft height that is compatible to the height of the truss, and the step of attaching the attachment means to the truss.

In a preferred embodiment of the invention, the length of the shaft is adjusted by rotating the upper bar in the internal threading of the block in a rotation direction, which can either be left or right rotation. Due to the rotation of the upper bar in the block, the block moves upwards or downwards depending on the rotation direction, which simultaneously pulls the bottom part upwards or pushes the bottom part downwards, thereby respectively decreasing or increasing the length of the shaft.

In a fourth aspect, the present invention relates to the use of a ventilation system according to the invention in a greenhouse.

### BRIEF DESCRIPTION OF THE DRAWINGS

The invention is further illustrated by the attached figures, wherein:

FIG. 1 shows an embodiment of a ventilation system according to the invention;

FIG. 2 shows a cross-sectional view from a front perspective of the ventilation system of FIG. 1;

FIG. 3 shows a cross-sectional view from a side perspective of the ventilation system of FIG. 1;

FIG. 4 shows an alternative embodiment of a ventilation system according to the invention;

FIG. 5 shows an embodiment of a ventilation system according to the invention when placed in a greenhouse.

### DETAILED DESCRIPTION OF THE INVENTION

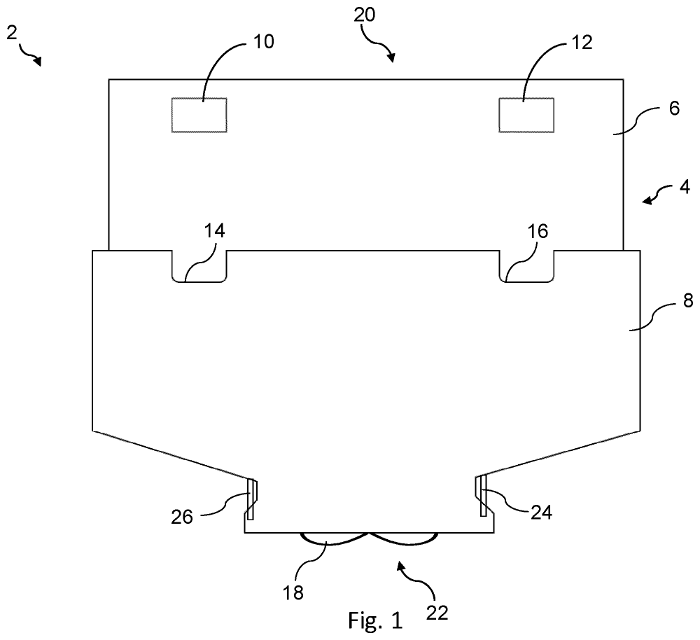

FIG. 1 shows an embodiment of a ventilation system, in particular for ventilating a greenhouse, according to the invention, which in its entirety is denoted by reference number 2. The ventilation system 2 comprises a shaft 4 manufactured from e.g. plastic or stainless steel, which comprises two parts, an upper part 6 and a lower part 8. The upper part 6 and the lower part 8 are telescopically connected such that the upper part 6 can slide into the bottom part 8 and the height of the shaft 4 can be adjusted. The shaft 4 comprises one or more attachment means 10, 12, in this case two hooks 10, 12, with which the shaft 4 can be attached to a truss near the roof of the greenhouse. The top edge of the bottom part 8 comprises one or more recesses 14, 16, the number of recesses 14, 16 corresponding to the number of attachment means 10, 12, into which the attachment means can extend. This allows the bottom part 8 to completely slide over the upper part 6. The bottom part 8 of the shaft 4 is open and a fan 18 is placed perpendicular to the mouth or opening of the bottom part 8. The fan 18 is configured for drawing in air through the shaft from the upper inlet side 20 at the top edge of the upper part 6 to the lower outlet side 22 at the open end of the bottom part 8. Two bars 24, 26 are mounted on the bottom part 8 or frame of the fan 18.

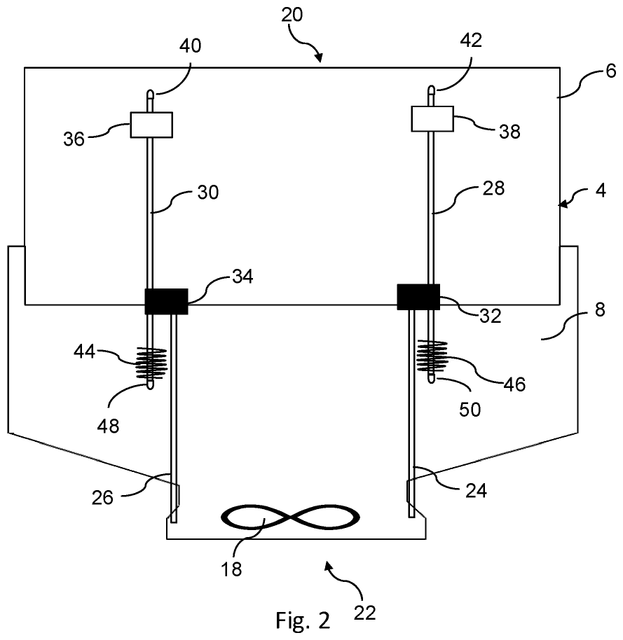

Shown in FIG. 2 is a cross-sectional view from a front perspective of a ventilation system 2 that comprises two extension systems according to an embodiment of the invention. The extension system is configured to adjust the height of the shaft 4 such that it fits the height of the truss to which it will be attached. Each extension system comprises a lower bar 24, 26 and an upper bar 28, 30. The lower bar 24, 26 is with one side fixedly mounted to the bottom part 8 or frame of the fan 18 of the shaft 4. The other side of the lower bar 24, 26 is fixedly connected to a block 32, 34, e.g. a threaded connection fixed with glue. The lower bar is preferably a screw thread for easy mounting. The upper bar 28, 30, also preferably a screw thread, protrudes through the same block 32, 34 and is furthermore rotatably mounted to the upper part 6 of the shaft 4 through coupling plates 36, 38 that are fixedly mounted to the upper part 6. The upper bar 28, 30 is thus rotatable with respect to the coupling plates 36, 38. The upper bar 28, 30 further comprises a cap nut 40, 42 fixedly mounted to coupling plate side of the bar 28, 30. The block 32, 34 through which the upper bar protrudes is internally threaded. When turning the cap nut 40, 42, for example by using a power wrench, the screw thread 28, 30 rotates in the block 32, 34 and simultaneously moves the block upwards or downwards (depending on the rotation direction) with respect to the upper bar. By moving the block 34, the lower bar 22, 24 and therewith the bottom part 8 is simultaneously raised and lowered over the upper part 6 during rotation of the cap nut 40, 42. The height of the shaft 4 is thereby increased or decreased. The upper bar 28, 30 comprises, at the protruding end of the bar, an additional cap nut 48, 50 and optionally a spring 44, 46 to prevent the bar from completely moving through the block, which would uncouple to bottom part and the upper part.

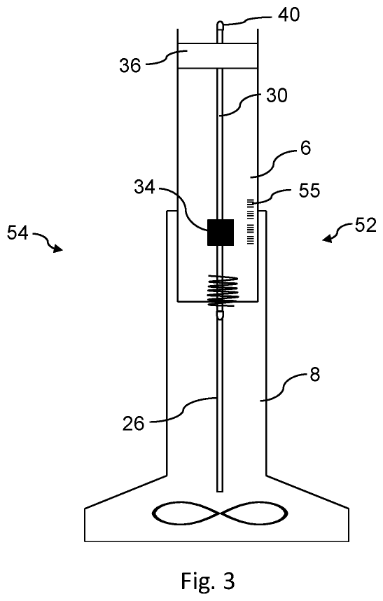

FIG. 3 shows a cross-sectional view of the ventilation system 2 from a side perspective to further illustrate the extension system. The ventilation system has a front face 52 and a back face 54. The lower bar 26 is fixedly mounted on the bottom part 8 or frame of the fan 18 and the block 34. The upper bar 30 is rotatably mounted in a coupling plate 36, said coupling plate being fixedly mounted to both the front face 52 and the back face 54 of the upper part 6. Advantageously, mounting the coupling plate 36 to the opposite faces of the shaft increases the stability and the strength of the shaft during operation of the ventilation system 2. The other side of the upper bar protrudes through the block 34. When turning the cap nut 40 at the coupling side of the upper bar 30, the bar 30 rotates in the internal threading of the block 34, thereby moving the block on the thread 30 and raising or lowering the bottom part 8. From these Figs. it appears that the shaft 4 in cross section has a flat configuration, similar to the gap width between adjacent climate screens wherein the shaft of the ventilation system is to be arranged. The shaft 4 may comprise a size indication 55 for easy adjusting the shaft to the required height.

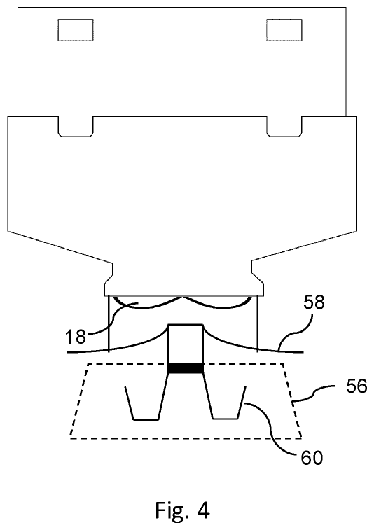

FIG. 4 shows the ventilation system of FIG. 1 with a second fan 56. The ventilation system is generally positioned vertically such as in FIG. 4. The first fan 18 displaces the air from the upper inlet side 20 to the lower outlet side 22 of the shaft 4 in a first air displacement direction, which in the figure is a vertical air displacement direction. An air deflector 58 can be placed beneath the first fan 18 to deflect the displaced air in a direction that is perpendicular to the first air displacement direction, in this case horizontally. Furthermore, a second fan 56 can be placed below the first fan 18, such as below the air deflector 58. The second fan 56 is configured for displacing air in a second air displacement direction which comprises a radial component as seen from the first air displacement direction by means of vertical blades 60. As a result, the fresh air from the ventilation system is mixed with the air already present in the growing space. This assures that there are no large climate fluctuations in the greenhouse and eliminates the need of a heating or cooling element. Alternatively, the second fan 56 can be placed separately in the greenhouse at a distance from the ventilation system 2 instead of being attached to the ventilation system 2.

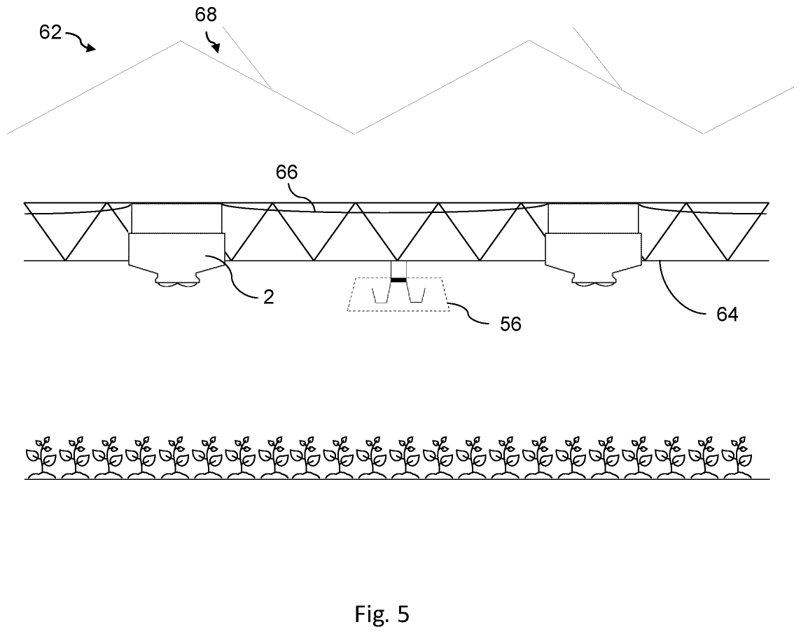

FIG. 5 depicts a ventilation system 2 according to an embodiment of the invention when placed in a greenhouse 62 which comprises a plurality of truss 64 and climate screens 66. The ventilation system 2 is attached to a truss 64. As the height of the truss 64 may vary from one greenhouse to another, the shaft 4 of the ventilation system 2 is adjusted in height before being attached to a truss 64. As such, the ventilation system 2 does not have to be custom made to match the required height of the truss 64 but can be made in bulk. This substantially increases the efficiency of manufacturing and decreases the required volume during transportation. The shaft of FIG. 1 is sufficiently flat that when the ventilation system hangs onto a truss 64, the shaft fits between the closed climate screens 66. Normally, when these climate screens 66 are closed, fresh air that enters through openings 68 in the ridge of the greenhouse 62 cannot move adequately to below the screens 66. Due to the narrow shaft 4 of the ventilation system 2 according to the invention, the ventilation system 2 fits in between these screens 66 and fresh air can be drawn into the greenhouse 62 despite the screens 66 being in place. The ventilation system 2 may comprise a second fan 56 positioned below the first fan 18 to distribute the air in the greenhouse 62 or can alternatively comprise a second fan 56 placed at a distance from the ventilation system 2.

1. A ventilation system for air ventilation in greenhouses, comprising
a shaft with an upper inlet side and a lower outlet side, wherein the shaft is configured for suspending from a truss, and
a first fan that is fluidly connected to the lower outlet side of the shaft,
wherein the first fan is configured for displacing air in a first air displacement direction from the upper inlet side to the lower outlet side of the shaft and into the greenhouse, and
wherein a height of the shaft is adjustable to a height of the truss.

2. The ventilation system according to claim 1, wherein the shaft comprises an upper part and a bottom part, wherein the upper part and the bottom part are telescopically arranged.

3. The ventilation system according to claim 2, wherein at least a portion of the upper part telescopically extends within the bottom part.

4. The ventilation system according to claim 2, wherein the telescopically arranged upper part and bottom part are connected by an extension system, wherein the extension system comprises
a block comprising internal threading,
a lower bar that is fixedly attached to the bottom part and the block, and
an upper bar comprising a threaded part, wherein the upper bar is rotatably attached to the upper part of the shaft and protrudes through the block, and wherein the threaded part of the upper bar engages the internal threading of the block.

5. The ventilation system according to claim 4, wherein the ventilation system comprises or more extension systems.

6. The ventilation system according to claim 1, wherein the height of the shaft is adjustable in the range of 10-80 cm.

7. The ventilation system according to claim 1, wherein the shaft comprises one or more attachment means for attaching the shaft to the truss.

8. The ventilation system according to claim 2, wherein the attachment means are mounted to the upper part of the shaft.

9. The ventilation system according to claim 8, wherein an upper edge of the bottom part comprises recesses for accommodating the attachment means when the shaft is in a retracted position.

10. The ventilation system according to claim 7, wherein the attachment means are interchangeable and/or extendable such that the attachment means are compatible to a width of a truss beam.

11. The ventilation system according to claim 1, wherein the shaft in cross section perpendicular to the first air displacement direction has a flat configuration.

12. The ventilation system according to claim 1, wherein the ventilation system comprises an air deflector attached to the first fan, wherein the air deflector is configured for deflecting air in a direction perpendicular to the first air displacement direction.

13. The ventilation system according to claim 1, further comprising a second fan configured for displacing air in a second air displacement direction, wherein the second air displacement direction comprises a radial component relative to the first air displacement direction.

14. The ventilation system according to claim 13, wherein the second fan comprises vertical blades.

15. The ventilation system according to claim 1, further comprising drive means configured for driving the first fan and/or second fan;
wherein the drive means are controlled by a climate control system.

16. (canceled)

17. A greenhouse comprising a plurality of trusses and climate screens and comprising at least one ventilation system according to claim 1 which is attached to a truss and is positioned in a gap in between adjacent climate screens.

18. The greenhouse according to claim 17, wherein the ventilation system is positioned vertically.

19. A method for installing a ventilation system according to claim 1 in a greenhouse, comprising the step of adjusting the height of the shaft, thereby obtaining a shaft height that is compatible to the height of the truss, and further comprising the step of attaching the attachment means to the truss.

20. The method according to claim 19, wherein adjusting the height of the shaft comprises rotating the upper bar in the internal threading of the block in a rotation direction, thereby moving the block upwards or downwards on the upper bar depending on the rotation direction, thereby decreasing or increasing the height of the shaft.

21. A method of ventilating comprising:
utilizing of a ventilation system according to claim 1 in a greenhouse.
